(19) United States
(12) Patent Application Publication
(10) Pub. No.: US 2013/0222851 A1
(43) Pub. Date: Aug. 29, 2013

(54) INFORMATION PROCESSOR, CONTROL DEVICE, AND IMAGE FORMING APPARATUS

(71) Applicants: Masayoshi KIKUTA, Kanagawa (JP); Masafumi ONO, Kanagawa (JP); Terutake HAYASHI, Kanagawa (JP); Kei HATANO, Kanagawa (JP); Yoshifumi BANDO, Kanagawa (JP); Shunsuke KASAHARA, Kanagawa (JP)

(72) Inventors: Masayoshi KIKUTA, Kanagawa (JP); Masafumi ONO, Kanagawa (JP); Terutake HAYASHI, Kanagawa (JP); Kei HATANO, Kanagawa (JP); Yoshifumi BANDO, Kanagawa (JP); Shunsuke KASAHARA, Kanagawa (JP)

(73) Assignee: FUJI XEROX CO., LTD., Tokyo (JP)

(21) Appl. No.: 13/603,011

(22) Filed: Sep. 4, 2012

(30) Foreign Application Priority Data
Feb. 24, 2012 (JP) 2012-038730

(51) Int. Cl. G06K 15/00; G06F 15/76

(52) U.S. Cl. 358/1.16; 712/1

(57) ABSTRACT

Provided is an information processor including: an operation unit performing logical operation or arithmetical operation; an execution unit executing predetermined functions based on the operation results; a clock signal generating unit generating a first clock signal to be a reference; a clock signal multiplying unit performing a multiplication operation on the first clock signal to generate a second clock signal; a clock signal selection unit selecting one of the first or second clock signals and supplies the selected signal to the execution unit; a memory storing data for setting the execution unit to be in an executable state in a readable and writable non-volatile memory; and a setting unit setting the execution unit to be in an executable state by causing the clock signal selection unit to select the first clock signal when reset is released and reading the data from the memory to start writing the data.

### CROSS-REFERENCE TO RELATED APPLICATIONS

This application is based on and claims priority under 35 USC 119 from Japanese Patent Application No. 2012-038730 filed Feb. 24, 2012.

### BACKGROUND

(i) Technical Field

The present invention relates to an information processor, a control device, and an image forming apparatus.

(ii) Related Art

An information processor is constituted with a Central Processing Unit (CPU) that executes logical operation or arithmetical operation and a control device that is constituted with an Application Specific Integrated Circuit (ASIC) and the like and executes predetermined functions by control of the CPU.

### SUMMARY

According to an aspect of the invention, there is provided an information processor including: an operation unit that performs logical operation or arithmetical operation; an execution unit that executes predetermined functions based on the operation results of the operation unit; a clock signal generating unit that generates a first clock signal to be a reference; a clock signal multiplying unit that performs a multiplication operation on the first clock signal to generate a second clock signal; a clock signal selection unit that selects one of the first and second clock signals and supplies the selected signal to the execution unit; a memory that stores data for setting the execution unit to be in an executable state in a readable and writable non-volatile memory which holds stored information even when power is not supplied; and a setting unit that sets the execution unit to be in an executable state by causing the clock signal selection unit to select the first clock signal when reset is released due to power being turned on and reading the data from the memory to start writing the data in the execution unit.

### BRIEF DESCRIPTION OF THE DRAWINGS

Exemplary embodiments of the present invention will be described in detail based on the following figures, wherein:

FIG. 1 is a view showing an example of the overall configuration of an information processor to which a first exemplary embodiment is applied;

FIG. 2 is a timing chart illustrating the operation of the information processor;

FIG. 3 is a view showing an example of the overall configuration of an information processor that includes a control device not having a clock signal selection portion;

FIG. 4 is a timing chart illustrating the operation of the information processor that includes the control device not having a clock signal selection portion;

FIG. 5 is a view showing an example of the configuration of an image forming apparatus;

FIG. 6 is a view illustrating the relationship between the image forming apparatus and instruments connected to a communication line;

FIG. 7 is a view showing an example of the overall configuration of an information processor to which a second exemplary embodiment is applied; and

FIG. 8 is a view showing an example of the overall configuration of an information processor to which a third exemplary embodiment is applied.

### DETAILED DESCRIPTION

Hereinbelow, the exemplary embodiments of the invention will be described in detail with reference to the attached drawings.

### First Exemplary Embodiment

Information Processor 1

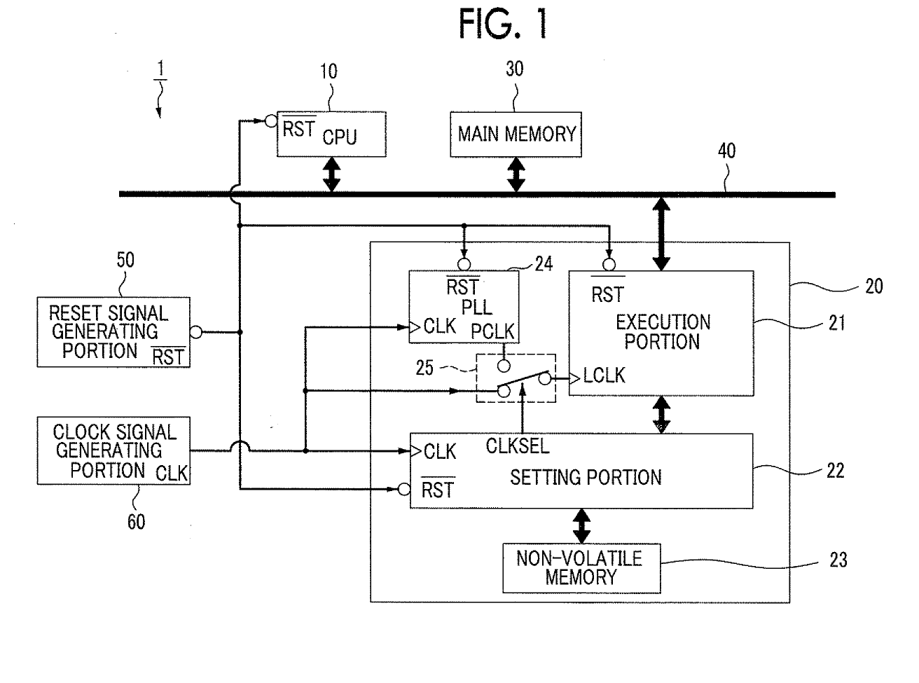

FIG. 1 is a view showing an example of the overall configuration of an information processor 1 to which a first exemplary embodiment is applied.

The information processor 1 includes a central processing unit (hereinbelow, described as “CPU”) 10 as an example of an operation unit including an Arithmetic Logical Unit (ALU) or the like that executes logical operation or arithmetical operation, a control device 20 that performs predetermined functions based on the operation results of the CPU 10, readable and writable main memory 30, a bus 40 that transmits data, addresses, commands, and the like, a reset signal generating portion 50 as an example of a reset signal generating unit that generates a reset signal (/RST) for instructing resetting as a predetermined state of the control device 20, and a clock signal generating portion 60 as an example of a clock signal generating unit that generates a clock signal CLK as an example of a first clock signal.

The clock signal CLK is a signal to be a reference in the information processor 1.

The main memory 30 may be a volatile memory such as DRAM or a non-volatile memory described later.

The information processor 1 may include a read-only memory (ROM).

The control device 20 includes an execution portion 21 as an example of an execution unit that executes predetermined functions, a setting portion 22 as an example of a setting unit that sets the execution portion 21 to be in an executable state when reset is released due to the reset signal (/RST), a non-volatile memory 23 that stores data for setting the execution portion 21 to be an executable state, Phase-Locked Loop (PLL) circuit 24 (hereinbelow, described as “PLL 24”) as an example of a clock signal multiplying unit that receives the clock signal CLK and generates a PLL clock signal PCLK as an example of a second clock signal generated by a multiplication operation using a predetermined multiplying factor, and a clock signal selection portion 25 as an example of a clock signal selection unit that selects and switches one of the clock signal CLK and the PLL clock signal PCLK as an execution portion clock signal LCLK inside the execution portion 21.

Similarly to the CPU 10, the execution portion 21 is constituted with a logical circuit including ALU, a sequencer, a counter, a register, and the like. That is, based on the command received from the CPU 10, the execution portion 21 accesses a memory, processes data taken from the memory, and the like, thereby executing functions predetermined in the control device 20.

If the PLL 24 is provided to the control device 20 so as to operate the execution portion 21 by using the PLL clock signal PCLK obtained by performing a multiplication operation on the clock signal CLK, the execution portion 21 operates at a higher speed, compared to a case where the execution portion 21 is operated using the clock signal CLK. In addition, compared to a case where the clock signal CLK is made into a high frequency signal, the execution portion 21 is not easily affected by noise and is easily operated at a high speed.

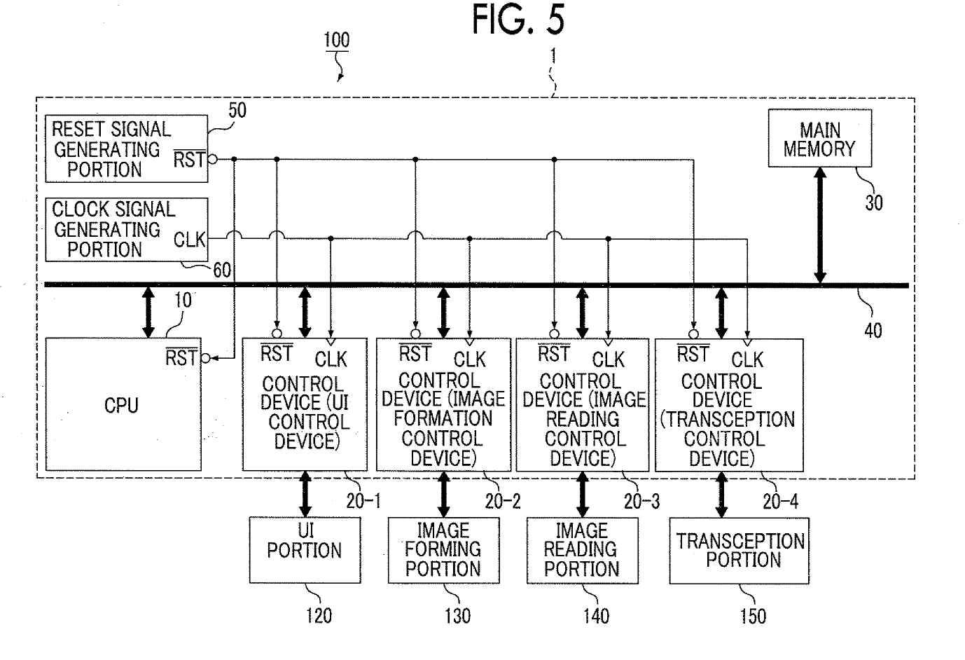

Regarding an example of the control device 20, an image forming apparatus 100 (FIG. 5 described later) as an example of an apparatus that uses the information processor 1 as a control portion will be described.

Herein, the execution portion 21, the setting portion 22, the non-volatile memory 23, and the clock signal selection portion 25 constitute the control device 20, as a single semiconductor chip by an ASIC or the like. Each of the execution portion 21, the setting portion 22, the non-volatile memory 23, and the clock signal selection portion 25 may constitute a single semiconductor chip, or some of them may constitute a semiconductor chip together.

In the present specification, a mark “/” in “/RST” or the like is (upper bar) placed above a symbol (letter or the like) following the mark and means that a signal represented by the symbol (letter or the like) is negative logic (in the drawing, the upper bar is marked on the symbol, and O is marked on a terminal).

Functions of the setting portion 22 will be described.

When reset is released since power is turned on from off, the control device 20 of the first exemplary embodiment sets the execution portion 21 to be in a state of being able to execute predetermined functions, regardless of control of the CPU 10.

The executable state of the execution portion 21 may be a state (initial state) of the execution portion 21 at the time when the control device 20 becomes executable for the first time, or may be a state where the execution of the execution portion 21 is resumed from an interrupted state when the execution of the execution portion 21 is interrupted.

Examples of the execution-interrupted state include a state immediately before the execution portion 21 shifts to an Off state from an On state (hereinbelow, described as a “state immediately before interruption”). Since the control device 20 is controlled by the execution portion 21, when the execution portion 21 is executable, the control device 20 also becomes executable. Hereinbelow, the execution portion 21 will be described, but the description is also applied in the same manner to the control device 20.

The data for setting the execution portion 21 to be in an initial state or in the state immediately before interruption are stored in the non-volatile memory 23.

When reset is released, the setting portion 22 reads the data for setting the execution portion 21 to be in an executable state (the initial state or the state immediately before interruption) from the non-volatile memory 23, and writes (sets) the data in the execution portion 21.

As described above, in the information processor 1 of the first exemplary embodiment, the control device 20 includes the setting portion 22. Accordingly, the execution portion 21 of the control device 20 may be set to be in an executable state, regardless of control of the CPU 10.

The data for setting the execution portion 21 to be in the state immediately before interruption are written (evacuated) in the non-volatile memory 23, immediately before the execution portion 21 shifts to an Off state from an On state, or whenever the execution portion 21 executes its function. In this manner, when the execution portion 21 has shifted to an On state from an Off state, the execution of the execution portion 21 may be resumed from the execution-interrupted state before the Off state begins.

Immediately before the execution portion 21 shifts to an Off state from an On state, when there is no time to write (evacuate) the data for setting the execution portion 21 to be in the state immediately before interruption into the non-volatile memory 23, the execution of the execution portion 21 fails to be resumed from the state immediately before interruption.

On the other hand, if the data for setting the state of the execution portion 21 (data of the register, counter, and the like, and data relating to the state of the sequencer, a flip flop, and the like) are written (evacuated) into the non-volatile memory 23 whenever the execution portion 21 executes its function, it is possible to resume execution of the execution portion 21 from the state immediately before interruption, even when there is no time to write (evacuate) the data for setting the execution portion 21 to be in the state immediately before interruption into the non-volatile memory 23.

When the setting portion 22 is constituted with hardware such as a sequencer, the execution portion 21 may be set to be in an executable state by hardware control. In this case, the time required to set the executable state is shortened (required time is short). However, the execution portion 21 may be set to be in an executable state by control performed by software (software control).

The non-volatile memory 23 has a function of storing data indicated as “1”/“0”. The term “non-volatile” means that data is stored when power is supplied and even when power is not supplied. Therefore, if the data for setting the execution portion 21 to be in an executable state are stored in the non-volatile memory 23, the data are not lost even if the execution portion 21 is in an Off state.

As the non-volatile memory 23, high-speed readable and writable non-volatile memories such as DRAM and SRAM are desirable. Such non-volatile memories include magnetoresistive RAM (described as “MRAM”), ferroelectric RAM (described as “FeRAM”), phase change RAM (described as “PRAM”), resistance RAM (described as “ReRAM”), and the like.

In MRAM, 2 sheets of magnetic laminated films are interposed between tunnel magnetoresistive films. By using a magnetoresistive (MR) effect by which resistance of the tunnel magnetoresistive film is changed due to a relative angle formed by magnetization of the stacked magnetic laminated films, MRAM stores information (“1”/“0”) FeRAM stores information (“1”/“0”) by using the polarization of ferroelectrics such as PZT (Pb (Zr,Ti) O₃). PRAM stores information (“1”/“0”) by resistance change accompanied by phase change of a chalcogenide. ReRAM stores information (“1”/“0”) by resistance change, by using great change in electric resistance caused by application of voltage (colossal electro-resistance (CER) effect).

With these non-volatile memories (MRAM, FeRAM, PRAM, and ReRAM), it is possible to arrange cells in a matrix shape on a semiconductor substrate with high density, similarly to DRAM and SRAM, and to perform reading and writing at a high speed by a driving circuit formed integrally. Moreover, a number of times of rewriting is basically unlimited or very large (hereinbelow, described a “there is little limitation on the number of times of rewriting”).

Consequently, it is easy to apply these MRAM, FeRAM, PRAM, ReRAM, and the like to the non-volatile memory 23.

The non-volatile memory also includes a flash memory that stores information (“1”/“0”) depending on whether there is charge accumulated in a gate electrode (floating gate) of a MOS transistor, Electrically Erasable Programmable ROM (EEPROM), and the like. With the flash memory and EEPROM, the state (“1”/“0”) is electrically readable and writable, but compared to the non-volatile memories described above (MRAM, FeRAM, PRAM, ReRAM, and the like), the speed of reading and writing, especially the speed of writing is slow. In addition, the number of times of rewriting is limited in the flash memory and EEPROM.

The flash memory and EEPROM may be applied to the non-volatile memory 23.

Volatile memories such as DRAM and SRAM may be used instead of the non-volatile memory 23. In this case, backup may be made using a battery or the like such that data may be stored even when the power of the information processor 1 is turned off.

Next, the connectional relationship and the flow of signals in the information processor 1 will be described.

The CPU 10, the execution portion 21 of the control device 20, and the main memory 30 are connected respectively to the bus 40 that is able to bidirectionally transceive data, addresses, commands, and the like. That is, the CPU 10, the control device 20 (execution portion 21), and the main memory 30 are connected to the bus 40 in parallel, and are able to transceive data, addresses, commands, and the like with each other via the bus 40.

The reset signal generating portion 50 generates a reset signal (/RST) and transmits it to the CPU 10 and the execution portion 21, the setting portion 22, and the PLL 24 of the control device 20.

The clock signal generating portion 60 generates a clock signal (CLK) and transmits it to the setting portion 22, the PLL 24, and the clock signal selection portion 25 of the control device 20.

In the control device 20, the execution portion 21 and the setting portion 22 are connected to each other via a bus that enables them to transceive data, addresses, commands, and the like with each other. Likewise, the setting portion 22 and the non-volatile memory 23 are connected to each other via a bus that enables them to transceive data, addresses, commands, and the like with each other.

The clock signal selection portion 25, which employs a 2-input and 1-output mode, selects and outputs one of the two inputs by switching.

One of the two inputs in the clock signal selection portion 25 is the clock signal CLK, and the other is the PLL clock signal PCLK generated by the PLL 24. One of the clock signal and the PLL clock signal PCLK is selected and becomes the execution portion clock signal LCLK as an output.

That is, the clock signal selection portion 25 selects (switches) one of the PLL clock signal PCLK and the clock signal CLK to obtain the execution portion clock signal LCLK.

The operation of the information processor 1 will be described.

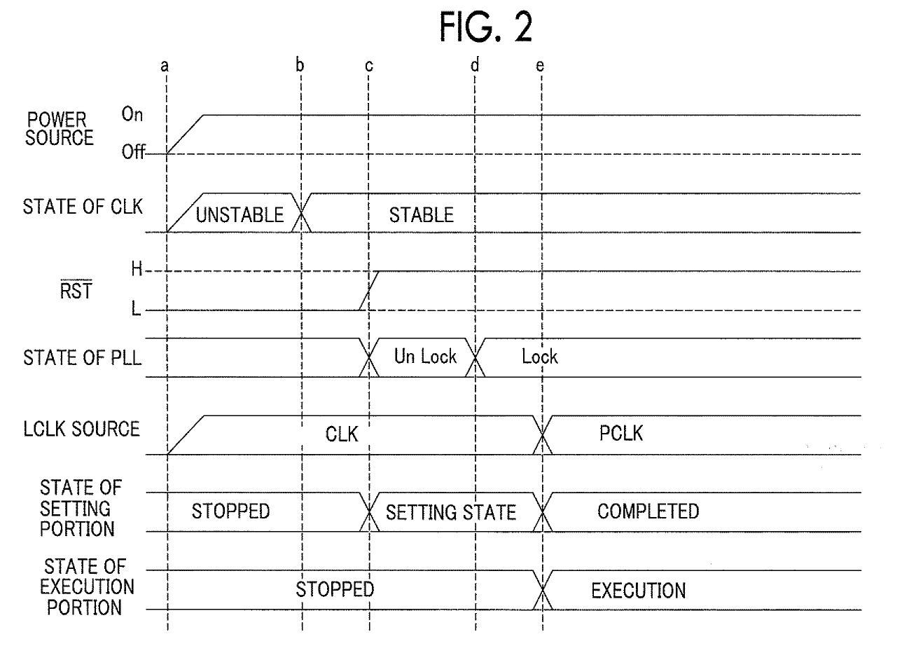

FIG. 2 is a timing chart illustrating the operation of the information processor 1. FIG. 2 shows On/Off states of power of the information processor 1 (described as “power” in FIG. 2; hereinbelow, the description in FIG. 2 will be described in parenthesis), the state of the clock signal generating portion 60 (state of CLK), the level of the reset signal (/RST) the state of the PLL 24 (state of PLL), the source of the execution portion clock signal LCLK (LCLK source), the state of the setting portion 22 (state of setting portion), and the state of the execution portion 21 (state of execution portion).

The reset signal (/RST) includes a high level (hereinbelow, described as “H”) and a low level (hereinbelow, described as “L”). For example, “L” is 0 V, and “H” is 5 V.

In addition, time elapses in an alphabetical order such as a time a, a time b, a time c, . . . .

At the time a when power of the information processor 1 is turned on, the reset signal (/RST) is “L”. When the reset signal (/RST) shifts to “H” from “L” (when reset is released), the CPU 10, the execution portion 21, the setting portion 22, and the PLL 24 start operating.

In addition, the clock signal selection portion 25 selects the clock signal CLK as the execution portion clock signal LCLK.

At the time a, power of the information processor 1 is turned on. Even if the power is turned on, immediately thereafter, the clock signal CLK is in such an unstable state (described as “unstable” in FIG. 2) that the frequency is not stabilized or oscillation amplitude is small.

At this time, the clock signal CLK has been transmitted to the execution portion 21, the setting portion 22, and the PLL 24 of the control device 20. However, the reset signal (/RST) is held at “L”, and the execution portion 21, the setting portion 22, and the PLL 24 are still in a stopped state. This is because after the power is turned on, if there is a component (for example, a crystal oscillator) that should wait for a while until the operation state is stabilized, the information processor waits until the operation state is stabilized. In this manner, unstable operation of the information processor 1 is inhibited.

At the time b, the clock signal CLK is stabilized.

Thereafter, at the time c following the time b when the clock signal CLK is stabilized, the reset signal generating portion 50 shifts the reset signal (/RST) to “H” from “L”, thereby releasing reset. The time difference between the time a and the time c may be obtained by providing an integration circuit or the like constituted with a capacitor (C) having a predetermined time constant and a resistance (R) to the reset signal generating portion 50.

As described above, the reset signal (/RST) is transmitted in parallel to the CPU 10, the execution portion 21, the setting portion 22, and the PLL 24, and when the reset signal (/RST) is released, the PLL 24 starts operating. However, immediately after the operation begins, the PLL clock signal PCLK output from the PLL 24 is in an unlocked state (described as “Un Lock” in FIG. 2) where the frequency and phase are shifted and unstable. Thereafter, the PLL 24 shifts to a locked state (described as “Lock” in FIG. 2) where the frequency and phase are controlled and stabilized by reaching a predetermined value. The unlocked state will be described as an unstable state, and the locked state will be described as a stable state, in some cases.

On the other hand, since a stabilized clock signal CLK is supplied to the execution portion 21 and the setting portion 22, the setting portion 22 starts a process (described as “state setting” in FIG. 2) for setting the execution portion 21 to be in an executable state. In addition, at the time c, the execution portion clock signal LCLK is the clock signal CLK.

At the time d, the PLL clock signal PCLK output from the PLL 24 is in the locked state.

At this time, the setting portion 22 keeps performing the process (state setting) for setting the execution portion 21 to be in an executable state. In addition at the time d, the execution portion clock signal LCLK is the clock signal CLK.

At the time e, the setting portion 22 completes the process (state setting) for setting the execution portion 21 to be in an executable state. In this manner, the execution portion 21 starts execution (described as “execution” in FIG. 2).

Subsequently, the setting portion 22 transmits a clock selection signal CLKSEL for instructing switching of the execution portion clock signal LCLK of the execution portion 21 to the PLL clock signal PCLK from the clock signal CLK, to the clock signal selection portion 25. In this manner, the clock signal selection portion 25 switches the execution portion clock signal LCLK of the execution portion 21 to the PLL clock signal PCLK from the clock signal CLK.

Thereafter, the execution portion 21 operates using the PLL clock signal PCLK as the execution portion clock signal LCLK.

As described above, in the present exemplary embodiment, a clock signal selection portion 25 is provided that selects one of the clock signal CLK and the PLL clock signal PCLK as the execution portion clock signal LCLK of the execution portion 21. As a result, even when the PLL 24 is in the unlocked state, the setting portion 22 may start the process (state setting) for setting the execution portion 21 to be in an executable state. Accordingly, it is not necessary to wait for the PLL 24 to be in the locked state.

In addition, in the above description, at the time e, that is, at the timing when the setting portion 22 completes the process (state setting) for setting the execution portion 21 to be in an executable state, the execution portion clock signal LCLK is switched to the PLL clock signal PCLK from the clock signal CLK. However, the switching timing for switching the execution portion clock signal LCLK may come after the time d when the PLL 24 is locked.

Consequently, the switching timing may be set to a time (a time longer than the time from the time c to the time d) required for the PLL 24 to be locked after the time c when the reset signal (/RST) shifts to “H” from “L”. The time is a predetermined time elapsing from when reset is released, and may be set by, for example, an integration circuit or the like constituted with a capacitor (C) having a predetermined time constant and a resistance (R).

In addition, a configuration may be employed in which when the PLL 24 is locked (when the lock is completed), that is, when the PLL clock signal PCLK is set to a predetermined value, the setting portion 22 receives a signal of lock completion from the PLL 24, whereby the time when the setting portion 22 receives the signal of lock completion may be set to be the switching timing.

The above three types of switching timing may be combined so as to create a switching timing in which two or three types of switching are performed.

Next, the control device 20 not including the clock signal selection portion 25 will be described in comparison with the control device 20 of the first exemplary embodiment.

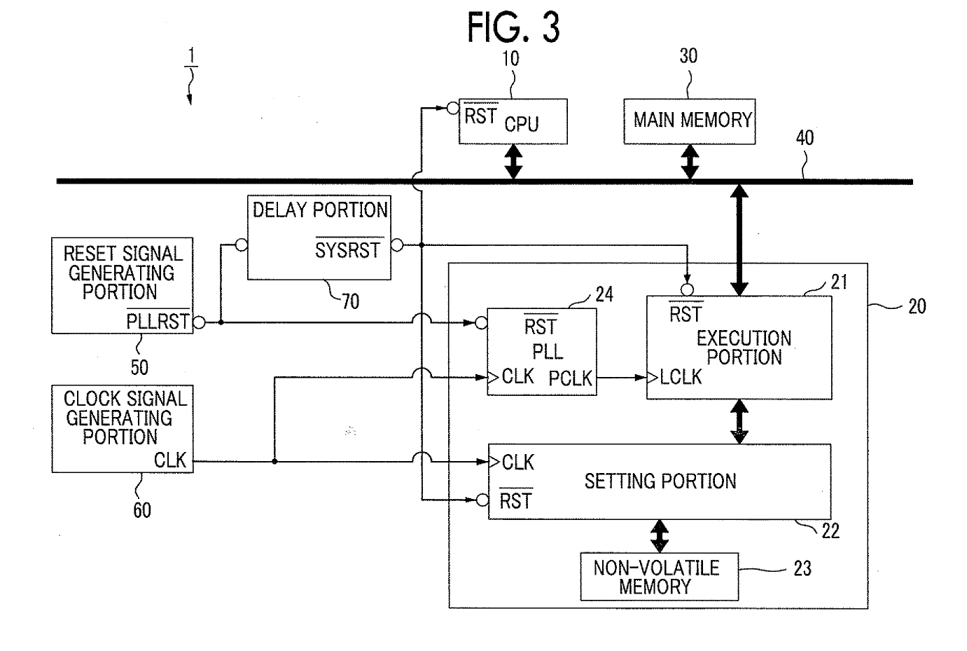

FIG. 3 is a view showing an example of the whole configuration of the information processor 1 including the control device 20 that does not have the clock signal selection portion 25.

In this information processor 1, the control device 20 does not include the clock signal selection portion 25, unlike the information processor 1 shown in FIG. 1. On the other hand, this information processor 1 includes a delay portion 70.

The delay portion 70 is connected to the reset signal generating portion 50, and delays the reset signal (/RST) generated by the reset signal generating portion 50. The delay portion 70 is, for example, an integration circuit or the like constituted with a capacitor (C) having a predetermined time constant and a resistance (R).

The reset signal generating portion 50 generates a PLL reset signal (/PLLRST) and transmits it to the PLL 24 and the delay portion 70 of the control device 20. The delay portion 70 receives the PLL reset signal (/PLLRST) and transmits a delayed SYS reset signal (/SYSRST) to the CPU 10 and the execution portion 21 and the setting portion 22 of the control device 20.

Meanwhile, the clock signal generating portion 60 transmits the clock signal CKL to the PLL 24 and the setting portion 22 of the control device 20. The PLL 24 generates the PLL clock signal PCLK and transmits it to the execution portion 21. Herein, the execution portion clock signal LCLK is the PLL clock signal PCLK. That is, since the clock signal selection portion 25 is not provided, the clock signal CLK is not usable as the execution portion clock signal LCLK.

Other configuration is the same as in FIG. 1, so the description thereof is omitted.

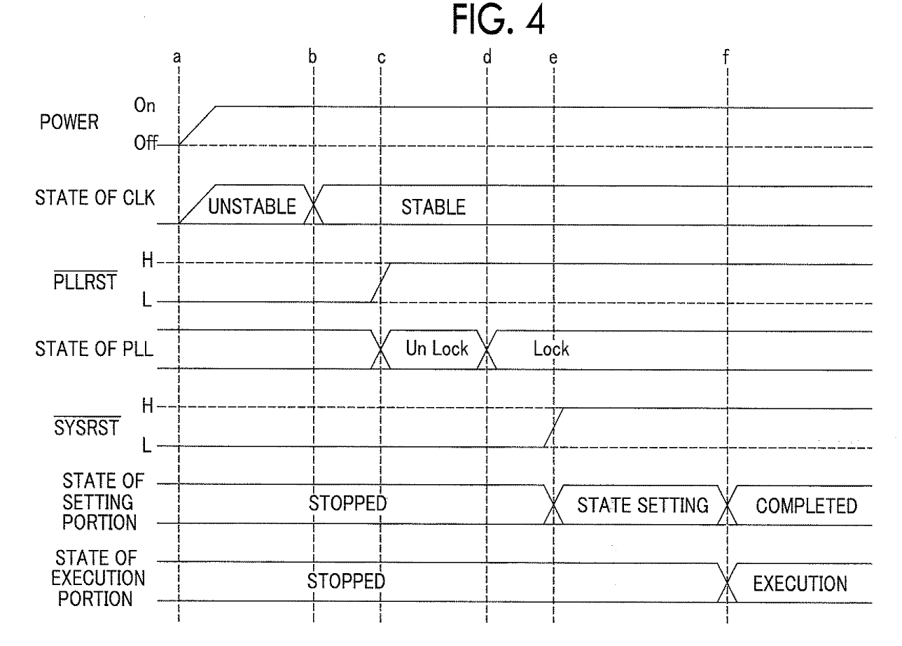

FIG. 4 is a timing chart illustrating the operation of the information processor 1 that includes the control device 20 not having the clock signal selection portion 25.

The time a, the time b, the time c, . . . are the same as those in the timing chart of FIG. 2.

Similarly to the FIG. 2, at the time a, power of the information processor 1 becomes an On state from an Off state, and at the time b, the clock signal CLK is stabilized.

At the time c following the time b when the clock signal CLK is stabilized, the reset signal generating portion 50 shifts the PLL reset signal (/PLLRST) to “H” from “L”. As a result, the PLL 24 releases reset and starts operating. Here, immediately after the operation begins, the PLL clock signal PCLK output from the PLL 24 is in an unlocked state (“Un Lock”) where the frequency and phase are shifted.

At the time d, the PLL clock signal PCLK output from the PLL 24 shifts to a locked state (“Lock”).

At the time e, the SYS reset signal (/SYSRST) that the delay portion 70 transmits to the execution portion 21 and the setting portion 22 shifts to “H” from “L”. As a result, reset is released for the execution portion 21 and the setting portion 22, and the setting portion 22 starts state setting for the execution portion 21. Accordingly, the execution portion 21 is set to be in an executable state. The timing when the SYS reset signal (/SYSRST) becomes “H” from “L” is set so as to come after when the PLL 24 is locked (after the time d).

At the time f, the setting portion 22 completes the state setting for the execution portion 21, and then the execution portion 21 starts executing.

FIG. 2 will be compared with FIG. 4.

The control device 20 in the information processor 1 of the first exemplary embodiment described using FIGS. 1 and 2 includes the clock signal selection portion 25 and is constituted such that the execution portion 21 may operate by the clock signal CLK. Accordingly, the execution portion 21 starts executing at the time e.

On the other hand, in the control device 20 not including the clock signal selection portion 25 described using FIGS. 3 and 4, state setting is performed after the PLL 24 is clocked (after the time d). Accordingly, the execution portion 21 starts executing at the time f.

That is, in the control device 20 in the information processor 1 of the first exemplary embodiment described using FIGS. 1 and 2, the time required until the execution begins is shortened (the time f of FIG. 4 becomes the time e of FIG. 2).

In FIG. 1, a single control device 20 is connected to the bus 40, but plural control devices 20 may be connected respectively to the bus 40.

As described above, the control device 20 includes the PLL 24 and operates the execution portion 21 by using the PLL clock signal PCLK that is obtained by a multiplication operation from the input clock signal CLK by the PLL 24, whereby the execution portion 21 operates at a higher speed compared to a case where it operates using the clock signal CLK. However, in this type of control device 20, in order to normally operate the execution portion 21, the PLL clock signal PCLK generated by the PLL 24 needs to be stabilized, that is, the PLL 24 needs to be locked.

Consequently, if the execution portion clock signal LCLK of the execution portion 21 is set to be the PLL clock signal PCLK, the execution portion 21 may not operate until the PLL 24 is locked. Accordingly, it takes time to start up the execution portion 21, the control device 20, and the information processor 1.

In this respect, in the first exemplary embodiment, it is possible to select and use one of the clock signal CLK and the PLL clock signal PCLK as the execution portion clock signal LCLK of the execution portion 21. As a result, when the PLL 24 is unlocked, the clock signal CLK that is already stabilized is set to be the execution portion clock signal LCLK, and state setting for setting the execution portion 21 to be in an executable state begins. That is, within the time required for starting up the execution portion 21, the time for which the PLL 24 is unlocked (duration from the time c to the time d in FIG. 4) may be shortened.

The frequency of the clock signal CLK is lower than that of the PLL clock signal PCLK that is generated by a multiplication operation performed on the clock signal CLK. Therefore, if the clock signal CLK is set to be the execution portion clock signal. LCLK, the operation of the execution portion 21 is more delayed compared to a case where the PLL clock signal PCLK is set to be the execution portion clock signal LCLK. However, since the state setting begins without waiting for the PLL 24 to be in a locked state, a rise time of the execution portion 21 is shortened.

In addition, the execution portion 21 may change a timing parameter for setting the operation of the execution portion 21, depending on whether the execution portion clock signal LCLK is the clock signal CLK or the PLL clock signal PCLK. In this manner, even if the execution portion clock signal LCLK is the clock signal CLK having a lower frequency compared to the PLL clock signal PCLK, it is possible to inhibit the delay of the operation of the execution portion 21.

The timing parameter is a timing of the signal that the execution portion 21 generates based on the execution portion clock signal LCLK.

For example, in the execution portion 21, a signal that is obtained by performing frequency dividing on the PLL clock signal PCLK generated by a multiplication operation of the PLL 24 is used in a circuit in a post-stage in some cases. In this case, when the execution portion clock signal LCLK is the clock signal CLK, delay of the operation of the circuit in the post-stage may be prevented by decreasing the ratio of frequency dividing.

When the PLL 24 performs a multiplication operation on the clock signal CLK by 4, the operation of the execution portion 21 by the clock signal CLK is decreased to ¼ of the operation performed by the PLL clock signal PCLK. At this time, if the ratio of frequency dividing for the signal provided to the circuit in the post-stage is set to ¼ times, decrease in the operation of the circuit in the post-stage may be inhibited.

In some cases, a lower limit is set to the frequency of an access signal, such as a case where the main memory 30 is Double-Data-Rate Synchronous Dynamic Random Access Memory (DDR SDRAM). In this case, when the execution portion 21 is operated using the clock signal CLK, the timing parameter of the access signal is changed such that the frequency of the access signal does not become far lower than the lower limit. In this manner, failure to access the main memory 30 may be inhibited.

The setting portion 22 transmits the clock selection signal CLKSEL to the clock signal selection portion 25. Accordingly, if the clock selection signal CLKSEL is also transmitted to the execution portion 21, the execution portion 21 may detect whether the execution portion clock signal LCLK is the clock signal CLK or the PLL clock signal PCLK. Consequently, the execution portion 21 may set the timing parameter according to the clock selection signal CLKSEL (execution portion clock signal LCLK).

The timing parameter may be selected from plural parameters prepared in advance by the clock selection signal CLKSEL, or may be set by calculating a ratio between the clock signal CLK and the PLL clock signal PCLK.

The information processor 1 may include plural control devices 20. If the plural control devices 20 transmit the reset signal (/RST) and the clock signal CLK in parallel, each of the execution portions 21 of the plural control devices 20 may be set to be in an executable state in parallel.

Next, a case will be described where the information processor 1 of the first exemplary embodiment is configured as a control portion of an image forming apparatus 100.

Image Forming Apparatus 100

FIG. 5 is a view showing an example of the configuration of the image forming apparatus 100.

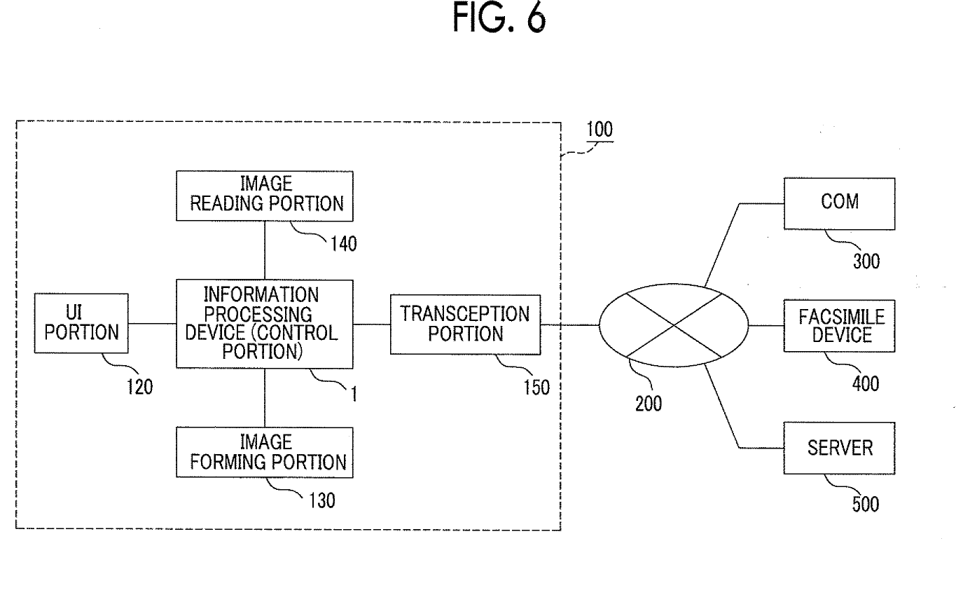

The image forming apparatus 100 includes the information processor 1 as a control portion, a user interface (UI) portion 120 such as a button for a user to provide instructions, an image forming portion 130 such as a printer, an image reading portion 140 such as a scanner, a communication line 200 (see FIG. 6 described later), and a transception portion 150 that transceiver data and the like.

The information processor 1 as a control portion includes four control devices 20-1 to 20-4. The control device 20-1 is a UI control device that has a function of controlling the UI portion 120, the control device 20-2 is an image formation control device that has a function of controlling the image forming portion 130, the control device 20-3 is an image reading control device that has a function of controlling the image reading portion 140, and the control device 20-4 is a transception control device that has a function of controlling the transception portion 150. In the description of the image forming apparatus 100, the control devices 20-1 to 20-4 will be described as a UI control device 20-1, an image formation control device 20-2, an image reading control device 20-3, and a transception control device 20-4 respectively.

The UI portion 120 is connected to the UI control device 20-1, the image forming portion 130 is connected to the image formation control device 20-2, the image reading portion 140 is connected to the image reading control device 20-3, and the transception portion 150 is connected to the transception control device 20-4, such that data, commands, and the like may be transceived.

Each of the UI control device 20-1, the image formation control device 20-2, the image reading control device 20-3, and the transception control device 20-4 is configured in the same manner as the control device 20 shown in FIG. 1. The execution portion 21 (see FIG. 1) of the UI control device 20-1 is connected to the UI portion 120 via a bus that enables them to transceive data, commands, and the like with each other. The image formation control device 20-2, the image reading control device 20-3, and the transception control device 20-4 are also configured in the same manner.

The reset signal generating portion 50 transmits the reset signal (/RST) to the UI control device 20-1, the image formation control device 20-2, the image reading control device 20-3, and the transception control device 20-4 in parallel. The clock signal generating portion transmits the clock signal CLK to the UI control device 20-1, the image formation control device 20-2, the image reading control device 20-3, and the transception control device 20-4 in parallel.

Each of the UI control device 20-1, the image formation control device 20-2, the image reading control device 20-3, and the transception control device 20-4 is the same as the control device 20 shown in FIG. 1. Accordingly, the reset signal (/RST) is received by each of the execution portion 21, the setting portion 22, and the PLL 24 in parallel (in FIG. 5, the reset signal is described as an individual signal). Likewise, the clock signal CLK is received by each of the setting portion 22, the PLL 24, and the clock signal selection portion 25 in parallel (in FIG. 5, the clock signal is described as an individual signal).

The UI portion 120 is an input instrument constituted with, for example, a button or a touch panel, and an instruction is input in this portion from a user. The UI control device 20-1 transmits the instruction from the user input in the UI portion 120 to the CPU 10, receives a command from the CPU 10, and controls the UI portion 120 to respond (to switch the input screen or the like) to the instruction from the user.

The image forming portion 130 may be either a printer that employs a method of writing a latent image on a photoreceptor drum by LED or the like, developing the latent image by using a toner, and transferring the image to a recording member such as paper, or a printer that employs a method of forming an image on a recording member by using an ink jet or the like. The image formation control device 20-2 transmits the image data inside the main memory 30 to the image forming portion 130, or receives the data relating to the operation state from the image forming portion 130 and transmits it to the CPU 10.

The image reading portion 140 may be either an image reading instrument that employs a method of causing a light-receiving element array facing a recording member on which an image is recorded to perform scanning, or an imaging instrument that employs a method of reading an image by using an imaging element such as CCD. The image reading control device 20-3 is placed between the CPU 10 and the image reading portion 140. The image reading control device 20-3 receives the data for setting reading conditions or the like of the image reading portion 140 from the CPU 10 and transmits it to the image reading portion 140, or receives the image data read by the image reading portion 140 and transmits it to the main memory 30.

The transception portion 150 receives data such as an image transmitted from a computer 300 or a facsimile device 400 via the communication line 200 (see FIG. 6 described later). The transception control device 20-4 transmits the data received by the transception portion 150 to the CPU 10 or the main memory 30. In addition, the transception portion 150 transmits data such as an image read by the image reading portion 140 to the computer 300 or the facsimile device 400 connected to the communication line 200, via the transception control device 20-4.

FIG. 6 is a view illustrating the relationship between the image forming apparatus 100 and instruments connected to the communication line 200.

The image forming apparatus 100 is connected to the communication line 200 such as the Internet, a telephone network, or the like, via the transception portion 150. In addition, the computer 300, the facsimile device 400, the server 500, and the like are connected to the communication line 200.

The basic operation of the image forming apparatus 100 will be described with reference to FIGS. 5 and 6.

The image forming apparatus 100 prints the image read by the image reading portion 140 on a recording member by the image forming portion 130.

The image forming apparatus 100 also prints the data such as an image, which is transmitted from the computer 300, the facsimile device 400, or the server 500 placed outside the image forming apparatus 100 via the communication line 200, on a recording medium by the image forming portion 130.

Meanwhile, the image forming apparatus 100 transmits the data such as an image read by the image reading portion 140 to the computer 300 and/or the facsimile device 400 placed outside the image forming apparatus 100 from the transception portion 150, via the communication line 200.

It is desirable that a current be not applied to the image forming apparatus 100 when the apparatus is not used. For example, the apparatus is set to be in a complete stop state where power is not supplied at all from a power source, or in a sleep state where a portion of the function is stopped for power saving. When the apparatus is to be used, it is desirable that the complete stop state or the sleep state be rapidly switched to an executable state.

Therefore, as shown in FIG. 5, if the information processor 1 in the first exemplary embodiment is used as a control portion of the image forming apparatus 100, the UI control device 20-1, the image formation control device 20-2, the image reading control device 20-3, and the transception control device 20-4 receive the reset signal (/RST) in parallel so as to release reset. Consequently, each execution portion 21 is operated using the clock signal CLK as the execution portion clock signal LCLK, and the setting portion 22 starts state setting for the execution portion 21.

Accordingly, as described above, compared to a case where the state setting for the execution portion 21 begins after the PLL 24 is clocked, the execution portion 21 may start execution in a short time.

### Second Exemplary Embodiment

Information Processor 1

In the information processor 1 of the first exemplary embodiment, the control device 20 includes the setting portion 22 and the non-volatile memory 23 in addition to the execution portion 21 and the PLL 24. In the information processor 1 of a second exemplary embodiment, the control device 20 includes the execution portion 21 and the PLL 24 but does not include the setting portion 22 and the non-volatile memory 23. Moreover, the setting portion 22 and the non-volatile memory 23 are taken as configurations separate from the control device 20.

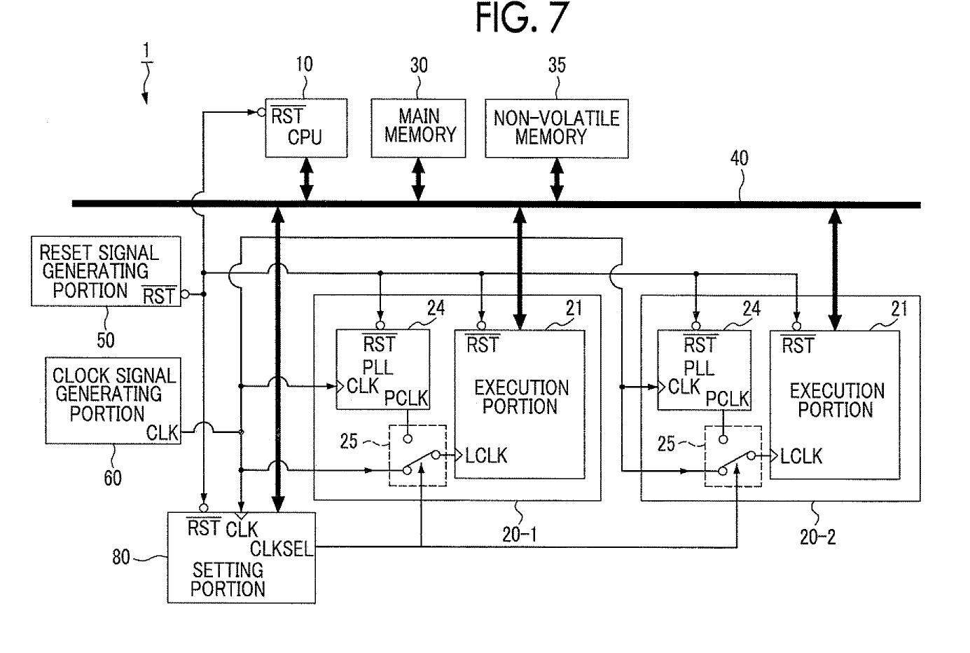

FIG. 7 is a view showing an example of the whole configuration of the information processor 1 to which the second exemplary embodiment is applied. In the second exemplary embodiment, the information processor 1 includes a non-volatile memory 35, a setting portion 80, and plural control devices 20, in addition to the CPU 10, the main memory 30, the reset signal generating portion 50, and the clock signal generating portion 60 in the information processor 1 of the first exemplary embodiment. Herein, the plural control devices 20 are described as control devices 20-1, 20-2, . . . . In FIG. 7, control devices 20-1 and 20-2 are shown.

Each of the control devices 20-1 and 20-2 includes the execution portion 21, the PLL 24, and the clock signal selection portion 25.

That is, the control device 20 of the information processor 1 of the second exemplary embodiment is configured such that the setting portion 22 and the non-volatile memory 23 are taken out of the control device 20 of the first exemplary embodiment and become the setting portion 80 and the non-volatile memory 35 respectively.

The control devices 20-1 and 20-2 and the setting portion 80 are configured by a separate ASIC or the like.

The reset signal generating portion 50 generates the reset signal (/RST) and transmits it to the CPU 10, the sett portion 80, and the execution portion 21 and the PLL 24 of each of the control devices 20-1 and 20-2 in parallel.

The clock signal generating portion 60 generates the clock signal CLK and transmits it to the setting portion 80 and the PLL 24 and the clock signal selection portion 25 of each of the control devices 20-1 and 20-2.

The setting portion 80 generates the clock selection signal CLKSEL and transmits it to the clock signal selection portion 25 of each of the control devices 20-1 and 20-2.

The operation of the information processor 1 of the second exemplary embodiment is the same as in the first exemplary embodiment. That is, after the power of the information processor 1 is turned on, and the clock signal CLK is stabilized, the reset signal (/RST) becomes “H” from “L” (time c of FIG. 2). Then the setting portion 80 and the execution portion 21 and the PLL 24 of each of the control devices 20-1 and 20-2 start operating. The setting portion 80 reads in order the data for setting each execution portion 21 to be in an executable state from the non-volatile memory 35, and performs state setting for each execution portion 21 in order.

Subsequently, after the PLL 24 is locked (time d in FIG. 2), each clock signal selection portion 25 switches the execution portion clock signal LCLK to the PLL clock signal PCLK from the clock signal CLK, by using the clock selection signal CLKSEL received from the setting portion 80.

The switching timing does not need to come after when setting (state setting) each execution portion 21 to be in an executable state is completed, just like the first exemplary embodiment. If the signal is switched in the middle of the state setting process, the time required for the state setting may be shortened.

When set to be in an executable state, each execution portion 21 starts execution.

The information processor 1 may start operating after all execution portions 21 are set to be in an executable state, or start operating in an order of the control devices 20-1 and 20-2.

Herein, there are two control devices including 20-1 and 20-2, but there may be more control devices such as control devices 20-3, . . . .

In addition, while the state setting is being performed for each execution portion 21, the setting portion 80 informs the CPU 10 of the “BUSY” state via the bus 40. Therefore, FIG. 7 does not show the path of a BUSY signal.

As described above, the setting portion 22 and the non-volatile memory 23 are taken out of the control device 20 of the first exemplary embodiment, so the size of the control devices 20-1, 20-2, . . . is reduced.

In addition, a pair of the setting portion 80 and the non-volatile memory 35 may perform state setting for each execution portion 21 of plural control devices 20-1, 20-2, . . . .

Moreover, since the non-volatile memory 35 is shared among the control devices 20-1, 20-2, . . . , efficiency of using the non-volatile memory 35 is improved.

The non-volatile memory 35 such as MRAM that may be accessed at a high speed may be used not only as an area where the data for performing state setting for each execution portion 21 are stored or evacuated, but also as the main memory 30.

In this case, if the operation system (OS), programs, texts, constants, variables, and the like are stored in the non-volatile memory 35, and temporarily used data and the like are stored in the volatile main memory 30 as a work area, the OS, programs, and the like do not need to be reloaded when the power of the information processor 1 is turned on again after being turned off. Therefore, it is possible to set the information processor 1 to be in an executable state in a short time.

### Third Exemplary Embodiment

Information Processor 1

The information processor 1 of a third exemplary embodiment uses both the control device 20 of the first exemplary embodiment and the control devices 20-1, 20-2, . . . of the second exemplary embodiment. That is, the control device 20 of the first exemplary embodiment includes the setting portion 22 and the non-volatile memory 23 in addition to the execution portion 21 and the PLL 24. On the other hand, the control devices 20-1, 20-2, . . . of the second exemplary embodiment include the execution portion 21 and the PLL 24 but does not include the setting portion 22 and the non-volatile memory 23.

Therefore, in the third exemplary embodiment, by using both the control device 20 (hereinbelow, described as a control device 20-0) in the first exemplary embodiment and the control devices 20-1, 20-2, . . . in the second exemplary embodiment, and using the setting portion 22 and the non-volatile memory 23 built in the control device 20-0, the control devices 20-1, 20-2, . . . are set to be in an executable state.

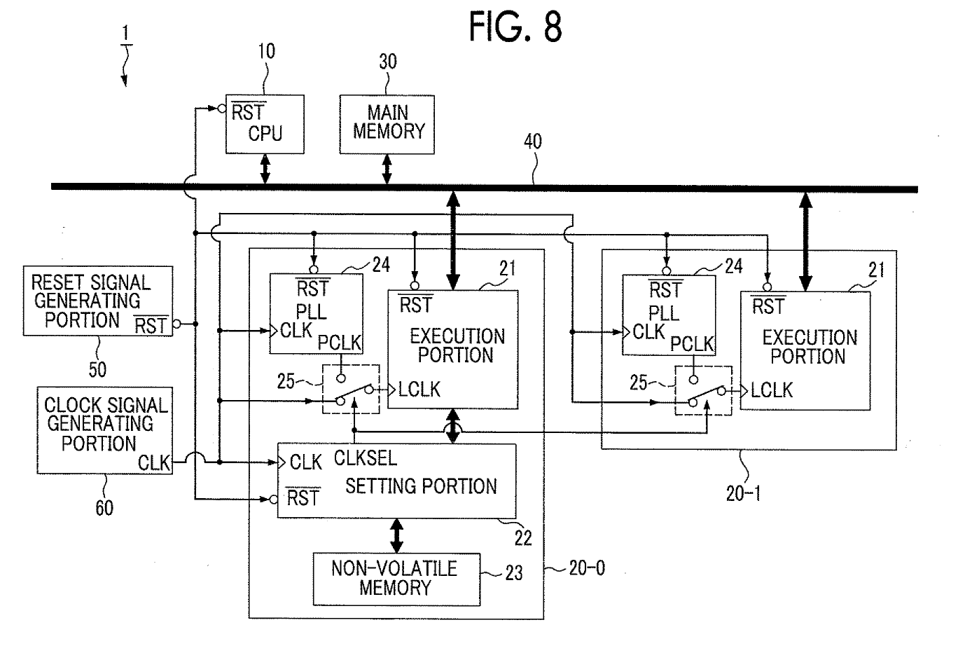

FIG. 8 is a view showing an example of the whole configuration of the information processor 1 to which the third exemplary embodiment is applied. FIG. 8 shows the control devices 20-0 and 20-1.

The same portions as those in the information processor 1 of the first exemplary embodiment will not be described, and the different portions will be described. The execution portion 21 of each of the control devices 20-0 and 20-1 is connected to the bus 40.

The setting portion 22 of the control device 20-0 transmits the generated clock selection signal CLKSEL to the clock signal selection portion 25 of the control device 20-0 and to the clock signal selection portion 25 of the control device 20-1.

The operation of the information processor 1 of the third exemplary embodiment is the same as in the second exemplary embodiment. That is, after power of the information processor 1 is turned on, and the clock signal CLK is stabilized, the reset signal (/RST) becomes “H” from “L” (time c of FIG. 2). Then the execution portion 21, the setting portion 22, and the PLL 24 of the control device 20-0 start operating. Likewise, the execution portion 21 and the PLL 24 of the control device 20-1 start operating. At this time, the execution portion 21 of the control device 20-0 and the execution portion 21 of the control device 20-1 operate by the clock signal CLK.

The setting portion 22 of the control device 20-0 reads the data for setting the execution portion 21 of the control device 20-0 to be in an executable state from the non-volatile memory 23 of the control device 20-0, and sets the execution portion 21 of the control device 20-0. When the execution portion 21 of the control device 20-0 is set to be in an executable state, the setting portion 22 reads the data for setting the execution portion 21 of the control device 20-1 to be in an executable state from the non-volatile memory 23, and sets the execution portion 21 of the control device 20-1. When there are control devices 20-2, . . . , the above setting is performed for each of control devices 20-2, . . . . In this manner, each execution portion 21 of all of the control devices 20-0, 20-1, 20-2, . . . , is set to be in an executable state.

At this time, the data for setting the execution portion 21 of the control device 20-1 to be in an executable state is read by the setting portion 22 of the control device 20-0 from the non-volatile memory 23, and read by the bus 40 via the execution portion 21 of the control device 20-0. Thereafter, the data are transmitted to the execution portion 21 of the control device 20-1 via the bus 40, whereby the execution portion 21 is set to be in an executable state.

In the meantime, each PLL 24 of the control devices 20-0 and 20-1 is locked, whereby the PLL clock signal PCLK is stabilized. After the PLL 24 is locked, the setting portion 22 of the control device 20-0 generates the clock selection signal CLKSEL and transmits it to each clock signal selection portion 25. Each clock signal selection portion 25 switches the execution portion clock signal LCLK of each execution portion 21 to the PLL clock signal PCLK from the clock signal CLK. The switching timing does not need to come after when the execution portion 21 of each control device 20 is set to be in an executable state, just like the first exemplary embodiment. If the signal is switched in the middle of the state setting, the time required for the state setting may be shortened.

When set to be in an executable state, each execution portion 21 of all of the control devices 20-0 and 20-1 starts execution.

Similarly to the information processor 1 of the second exemplary embodiment, the information processor 1 may start operating after execution portions 21 of all of the control devices 20-0, 20-1, . . . are set to be in an executable state, or start operating in an order of the control devices 20-0, 20-1, . . . .

As described above, in the information processor 1 of the third exemplary embodiment, a rise time of each execution portion 21 of the control devices 20-0, 20-1, . . . is shortened, just like the first and second exemplary embodiments.

In addition, since both the control device 20 (control device 20-0) of the first exemplary embodiment and the control device 20 (control device 20-1, . . . ) of the second exemplary embodiment are used, the size of the control device 20-1, . . . may be reduced.

Moreover, since the non-volatile memory 23 is shared among the control devices 20-0, 20-1, 20-2, . . . , efficiency of using the non-volatile memory 23 is improved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processor comprising:
an operation unit that performs logical operation or arithmetical operation;
an execution unit that executes predetermined functions based on the operation results of the operation unit;
a clock signal generating unit that generates a first clock signal to be a reference;
a clock signal multiplying unit that performs a multiplication operation on the first clock signal to generate a second clock signal;
a clock signal selection unit that selects one of the first and second clock signals and supplies the selected signal to the execution unit;
a memory that stores data for setting the execution unit to be in an executable state in a readable and writable non-volatile memory which holds stored information even when power is not supplied; and
a setting unit that sets the execution unit to be in an executable state by causing the clock signal selection unit to select the first clock signal when reset is released due to power being turned on and reading the data from the memory to start writing the data in the execution unit.

2. The information processor according to claim 1,
wherein the data stored in the memory are data written in the execution unit so as to initially set the executable state or data written in the execution unit so as to set the executable state by resuming the execution from when the execution is interrupted.

3. The information processor according to the claim 1,
wherein the setting unit causes the clock signal selection unit to select the second clock signal at least at a time that comes after a predetermined time elapses from when the reset is released, after a signal that shows that the second clock signal is set to a preset value is received from the clock signal multiplying unit, or after the execution unit is set to be in an executable state.

4. The information processor according to the claim 2,
wherein the setting unit causes the clock signal selection unit to select the second clock signal at least at a time that comes after a predetermined time elapses from when the reset is released, after a signal that shows that the second clock signal is set to a preset value is received from the clock signal multiplying unit, or after the execution unit is set to be in an executable state.

5. The information processor according to claim 1,
wherein the execution unit sets a timing of the signal generated to execute the predetermined functions, in response to each of the first and second clock signals supplied.

6. The information processor according to claim 2,
wherein the execution unit sets a timing of the signal generated to execute the predetermined functions, in response to each of the first and second clock signals supplied.

7. The information processor according to claim 3,
wherein the execution unit sets a timing of the signal generated to execute the predetermined functions, in response to each of the first and second clock signals supplied.

8. The information processor according to claim 4,
wherein the execution unit sets a timing of the signal generated to execute the predetermined functions, in response to each of the first and second clock signals supplied.

9. The information processor according to claim 1,
wherein the non-volatile memory is one of MRAM, FeRAM, PRAM, and ReRAM.

10. The information processor according to claim 2,
wherein the non-volatile memory is one of MRAM, FeRAM, PRAM, and ReRAM.

11. The information processor according to claim 3,
wherein the non-volatile memory is one of MRAM, FeRAM, PRAM, and ReRAM.

12. The information processor according to claim 4,
wherein the non-volatile memory is one of MRAM, FeRAM, PRAM, and ReRAM.

13. The information processor according to claim 5,
wherein the non-volatile memory is one of MRAM, FeRAM, PRAM, and ReRAM.

14. The information processor according to claim 6,
wherein the non-volatile memory is one of MRAM, FeRAM, PRAM, and ReRAM.

15. The information processor according to claim 7,
wherein the non-volatile memory is one of MRAM, FeRAM, PRAM, and ReRAM.

16. The information processor according to claim 8,
wherein the non-volatile memory is one of MRAM, FeRAM, PRAM, and ReRAM.

17. A control device comprising:
a clock signal multiplying unit that performs a multiplication operation on a first clock signal supplied from the outside to generate a second clock signal;
a clock signal selection unit that selects one of the first and second clock signals; and
an execution unit that executes predetermined functions by a process in which the first clock signal is supplied when reset is released due to power being turned on, data are read from a readable and writable non-volatile memory that holds stored information even when power is not supplied, and writing starts to set the execution unit to be in an executable state.

18. The control device according to claim 17, further comprising:
a memory that stores data for setting the execution unit to be in an executable state in the non-volatile memory; and
a setting unit that causes the clock signal selection unit to select the first clock signal when reset is released due to power being turned on, and reads the data from the memory to start writing the data in the execution unit.

19. The control device according to claim 17,
wherein the non-volatile memory is one of MRAM, FeRAM, PRAM, ReRAM.

20. An image forming apparatus comprising:
an image forming portion that forms an image on a recording member; and
a control unit that includes an operation unit performing logical operation or arithmetical operation, an execution unit executing predetermined functions based on the operation results of the operation unit, a clock signal generating unit generating a first clock signal to be a reference, a clock signal multiplying unit generating a second clock signal by performing a multiplication operation on the first clock signal, a clock signal selection unit selecting one of the first and second clock signals and supplying the selected signal to the execution unit, a memory storing data for setting the execution unit to be in an executable state in a readable and writable non-volatile memory that is able to hold stored information even when power is not supplied, and a setting unit setting the execution unit to be in an executable state by causing the clock signal selection unit to select the first clock signal when reset is released due to power being turned on and reading the data from the memory to start writing the data in the execution unit, and controls the image forming portion.
